(19) United States
(12) Patent Application Publication
(10) Pub. No.: US 2026/0341158 A1
(43) Pub. Date: Oct. 29, 2026

(54) Marine Detection System and Method

(71) Applicant: Ørsted Wind Power A/S, Fredericia Skaerbaek (DK)

(72) Inventors: Marie-Lou PICHERIT, Providence, RI (US); Mikkel Haugaard WINDOLF, Gentofte (DK)

(21) Appl. No.: 19/486,214

(22) PCT Filed: Apr. 26, 2024
(86) PCT No.: PCT/EP2024/061591

§ 371 Date: Nov. 20, 2025

(51) Int. Cl. G08G 3/02; B63B 43/18; B63B 79/15; B63B 79/20; B64U 20/80; G01S 13/86; G01S 13/937; G06V 10/774; G06V 10/82; G06V 20/05; G06V 40/10

(52) U.S. Cl. CPC G08G 3/02; B63B 43/18; B63B 79/15; B63B 79/20; B64U 20/80; G01S 13/862; G01S 13/865; G01S 13/867; G01S 13/937; G06V 10/774; G06V 10/82; G06V 20/05; G06V 40/10; B64U 2201/10

(57) ABSTRACT

Marine detection system and method for detecting marine bodies (8). The system includes a first sensor (6) for detecting marine bodies in a first detection region. A second sensor (3) is provided for detecting marine bodies in a second detection region. The second sensor is a different type of sensor to the first sensor and the second detection region overlaps with or is adjacent to the first. A controller (5) is provided including a neural network for processing data from the first and second sensors, where the neural network is trained to determine the presence of a marine body (8) based on the sensor data characteristics, and a signal indicating the presence of the marine body is output based on the determination by the neural network.

### INTRODUCTION

The present invention relates to a marine detection system and method for detecting marine bodies. The disclosure is particularly relevant to whale detection systems and marine debris detection systems, as well as collision avoidance systems for vessels to avoid collisions with marine bodies. As such, the disclosure may provide improved situational awareness for a variety of vessel types and use applications for protecting marine mammals worldwide. This, in turn, may provide for improved risk reduction compared to current use of speed restriction regulations.

### BACKGROUND

Offshore wind farms are becoming increasingly common around the world as a way to generate renewable energy. However, the construction and operation of wind farms typically increases marine traffic to and from the area, which risks increasing the chances of collisions between marine vessels and larger marine animals such as whales. At the same time, the impact of climate change on ocean conditions, prey distribution, behaviours and habitats mean that the migration patterns of large marine animals are less predictable.

To address this, boat speed restrictions are normally imposed around offshore wind farms and between the wind farm and shore to protect whales. For instance, speeds may be limited to 10 knots to lower the probability of a strike and associated damage in the event of a collision, as well as to allow for vessels to attempt to steer around marine animals. Whale and Marine watching personnel, often called PSOs (Protected Species Observers) or MMOS (Marine Mammal Observers), are also often provided on vessels to spot whales and raise an alert for the vessel to be stopped if a whale is spotted. PSOs/MMOs are effective in most situations for monitoring animals at the surface in a potential vessel strike zone. However, they are often not practicable or fully effective in all vessel operation conditions. For example, visual conditions, observer fatigue, complacency, and experience level may affect detection ability. Furthermore, often several observers would be required which is difficult to resource on some vessels (e.g., for lack of space).

To aid the above, more recently, camera-based systems mounted on the vessel have also been used to help PSOs/MMOs spot whales and other marine life ahead of the vessel. However, such systems are not entirely reliable in practice and are particularly suspectable to poor weather. For instance, camera-based systems have a limited range, and are limited by the resolution of the camera, whether the lens is camera lens is dry and clear, and the movement of the vessel in the water. The latter has a particularly detrimental effect on performance as larger waves make it very difficult to stabilise the camera's field of view. At the same time, camera systems, including infrared/thermal camera systems, have limited depth penetration and hence can often fail to identify whales that are deeper in the water. The result is such camera systems are often only effective at short ranges and hence, whilst they may help to minimise the risk of collisions, boat speed restrictions remain necessary. As such, these conventional solutions are not logistically or economically ideal for the operation and maintenance of offshore wind farms. To mitigate these limitations, regional monitoring methods and current adaptive plans (e.g., transit corridors, real-time acoustic monitoring) have been adopted, but these typically restrict vessels to certain pathways, which may not be economical and can increase transit times and distances. In addition, such solutions have the potential to create a single point of failure in which a breakdown in one monitoring system could impact the whole fleet. Finally, such regional methods are not appropriate for monitoring the fine scale movements of individual vessels.

A major consequence of limiting the speed of vessels to and from a wind farm is that it prolongs installation and servicing times. Supplies and staff take much longer to reach the site, which has a massive impact on costs. In addition, the health and welfare of staff is also detrimentally impacted by prolonged slow transit and associated sea sickness with an increased time spent on the water. The need to manage crew welfare around these constraints often necessitates more vessel traffic, which in turn exacerbates the risks of marine accidents and increases costs further. As such, there is a need to address the above problems with vessel speed restrictions associated with wind farms.

### SUMMARY

According to a first aspect, there is provided a marine detection system for detecting marine bodies, comprising: a first sensor for detecting marine bodies in a first detection region; second sensor for detecting marine bodies in a second detection region, wherein the second sensor is a different type of sensor to the first sensor and at least part of the second detection region overlaps with the first detection region; and a controller comprising: a neural network for processing data from the first and second sensors, wherein the neural network is trained to determine the presence of a marine body based on sensor data characteristics in the first and second detection regions, and an output for outputting a signal indicating the presence of the marine body based on the determination by the neural network.

In this way, by combining the sensor data of two or more different types of sensors directed to overlapping areas of an environment surrounding a vessel, a greater ability to detect marine bodies may be achieved. In particular, the arrangement allows improved detection of marine bodies in a so-called ‘boundary layer’ of the surface between water and air. That is, spotting marine bodies just below the sea surface is often challenging because conventional techniques typically rely on being able to detect a short-term anomaly when, for instance, a whale breaks or breaches the surface. However, if that whale then disappears just below the surface, the above surface visual indicators may no longer be present as the whale sinks just below the surface (e. g. 0-5 meters). At the same time, waves forming the wave-surface commonly vary up to 2-3 meters from top to bottom which makes it possible for marine objects to avoid clear detection, being masked by the movement of the waves and noise. Instead, the presence of marine objects may manifest as intermittent small anomalies, which the machine learning model is able to identify. Accordingly, by combining detection from different sensor types, characteristic anomalies detected in different sensor types concurrently can be cross correlated to detect marine bodies more accurately. For instance, in one embodiment, three sensor types are used, such as active sonar, radar, and IR/HR cameras, with these inputs being integrated via a data processor for detecting marine mammals, debris and other objects ahead of the vessel. The combination of sensors may provide complementary strengths to maximize detection. For example, marine bodies can be spotted and tracked across multiple sensors when relevant. For example, a whale coming to the surface may first be detected by sonar and radar, but then spotted on an IR camera feed, with the system identifying this as the same whale. The system may allow multiple targets to be identified in this way.

With the above, the technology may be equally or more effective than speed restrictions at reducing vessel strike. Consequently, vessels such as ships or boats, may be able to travel at higher speeds without risking collisions with marine bodies, such as whales or debris. In turn, regulators may therefore be willing to lift speed restrictions, providing for potential cost savings associated with faster vessel travel. In preferred embodiments, the first sensor may be a sonar transceiver and the second sensor may be a camera and/or IR camera, mounted to the vessel or to a drone. The drone may be controlled in coordination with the vessel. The sonar transceiver may be a forward-facing sonar transceiver.

In embodiments, the first and second detection regions are at a predetermined position relative to a vessel.

In embodiments, the predetermined position is ahead of the vessel in its primary direction of travel. In this way, each sensor's detection area, such as its field of view, is located in front of its typical travel direction. For example, this may be a region of water ahead of a ship's bow. This may thereby minimise the risk of the vessel colliding with marine bodies as it sails through the water As such, situational awareness parameters may be improved in all conditions as objects within a reliable detection range will be detected. This may then be used along with vessel dependent parameters such as the manoeuvrability of the vessel and time between detection and action to provide improved reaction time overall.

In embodiments, at least one of the first and second sensors are mounted to the vessel.

In embodiments, the marine detection system further comprises one or more further sensors for detecting marine bodies in one or more further detection regions which overlap with the first or second detection regions, and wherein the neural network further processes data from the one or more further sensors and is further trained to determine the presence of a marine body based on sensor data characteristics from the further sensors. In this way, three or more sensors may be used in combination to detect marine bodies to further improve the accuracy of detection.

In embodiments, the neural network is trained to recognize features associated with marine bodies in the sensor data.

In embodiments, the neural network is configured to have a confidence threshold where a positive detection of a marine body is based on aggregated detection of characteristics associated with marine bodies in the sensor data. In this way, detection accuracy may be improved by combining different types of sensors into a combined system.

In embodiments, the controller is configured to generate a marine body collision avoidance signal in response to the signal indicating the presence of the marine body. In this way, the vessel may automatically be controlled to break or steer away from the marine body to avoid a collision. For example, in a further aspect, an autonomous marine control system is provided comprising: a first sensor for detecting marine bodies in a first detection region; a second sensor for detecting marine bodies in a second detection region, wherein the second sensor is a different type of sensor to the first sensor and at least part of the second detection region overlaps with the first detection region; and a controller comprising: a neural network for processing data from the first and second sensors, wherein the neural network is trained to determine the presence of a marine body based on sensor data characteristics in the first and second detection regions, and an output for outputting a control signal for controlling the autonomous vessel, wherein the control signal is modified when the neural network determines the presence of the marine body for controlling the autonomous vessel to avoid a collision with the marine body.

In embodiments, the controller is configured to generate a marine body classification signal for classifying the marine body. In this way, marine bodies may be categorised based on characteristics of the sensor detection inputs. For instance, neural network image analysis may be used. As such, different types of marine bodies may be differentiated, such as differentiating marine animals from marine debris. This information may be provided to crew or navigation systems to support decision making on how to respond to the detection.

In embodiments, the neural network is further trained to determine a travel vector of the marine body based on the sensor data characteristics and wherein the output outputs a signal indicating the travel vector of an identified marine body. In this way, collisions may be more effectively avoided by turning the vessel away from the travel direction of the marine body.

In embodiments, the sensors include one or more of the following types: forward facing SONAR, camera, infrared camera, RADAR, and passive acoustic monitoring sensors.

In embodiments, the marine bodies comprise whales. In this way, the system may be used to detect large marine animals, as well as other marine bodies such as other vessels, debris, turbines, buoys, etc.

In embodiments, the controller further comprises a drone controller block for controlling a drone to maintain a predetermined position ahead of a vessel associated with the first and second detection regions, and wherein at least one of the sensors is mounted to the drone. In this way, the visual field or thermal camera sensing range ahead of the vessel may be increased to provide better advance warning of marine bodies.

According to a second aspect, there is provided a marine detection method for detecting marine bodies, comprising the steps of: receiving sensor data from a first sensor for detecting marine bodies in a first detection region; receiving sensor data from a second sensor for detecting marine bodies in a second detection region, wherein the second sensor is a different type of sensor to the first sensor and at least part of the second detection region overlaps with the first detection region; processing data from the first and second sensors using a neural network trained to determine the presence of a marine body based on sensor data characteristics in the first and second detection regions; and outputting a signal indicating the presence of the marine body based on the determination by the neural network.

In embodiments, the first and second detection regions maintain a predetermined position ahead of a vessel as the vessel moves through the water.

According to a third aspect, there is provided a method for training a neural network to detect marine bodies, comprising the steps of: acquiring a data set of first and second sensor data that includes marine body characteristics, wherein the second sensor is a different type of sensor to the first sensor, and the first and second sensor data is for first and second detection regions, where at least part of the second detection region overlaps with the first detection region; and training the neural network using the data set by adjusting weights and biases in the neural network to minimize the loss function. In this way, a training method is provided for training a neural network for use in the above-described system.

### BRIEF DESCRIPTION OF DRAWING

Illustrative embodiments of the present invention will now be described with reference to the accompanying drawing in which:

FIG. 1 shows an illustrative marine detection system installed on vessel according to a first example in this disclosure.

### DETAILED DESCRIPTION

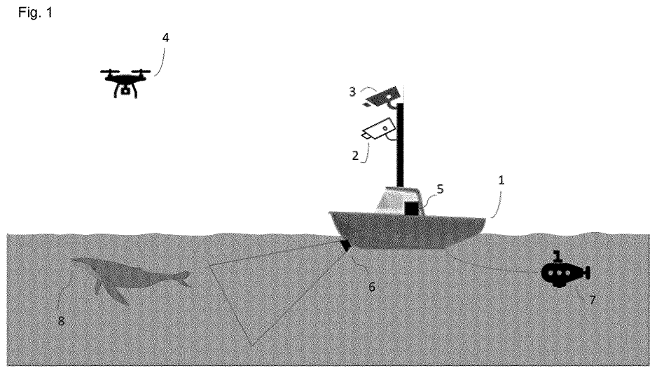

Referring to FIG. 1, a marine vessel 1 is shown with an example implementation of a marine detection system used to detect marine bodies 8, such as whales, other marine life, and floating debris and fishing nets.

The marine detection system comprises a plurality of environment perception sensors, which are controlled and processed by a central controller 5. In the illustrative example, a number of example environment perception sensor types are shown, however it will be understood that embodiments of the invention may incorporate combinations of two or more sensor types, which may include the sensors illustrated here as well as others.

In this connection, the sensor types shown include camera 2 and infrared (thermal) camera 3 being mounted in an elevated position on the vessel 1, with their field of view being directed forward and down to the waterline ahead of the vessel 1. In other embodiments, one or more IR cameras 3 may be mounted to the bow of the vessel 1.

A drone 4 is further provided with a camera unit for capturing images with ahead of the field of view range associated with the vessel mounted cameras. That is, the drone 4 is controlled by controller 5 to maintain flight at a specified position ahead of the vessel 1 in a coordinated manner. For example, the controller 5 may include a functional controller block for controlling the drone 4. Consequently, as the vessel 1 moves forward through the water, the drone 4 flies forward to maintain a substantially fixed distance ahead of the vessel. The specified position may be set to be, for example, 1000 m-3000 m, and optimally around 2500 m, in front of the vessel at an appropriate height depending on its camera's resolution, field of view, and regulatory requirements. The drone's field of view may therefore be adjacent to the vessel mounted cameras (e.g. IR camera range of 500-1000 m) or overlap with the vessel's sonar range (e.g. 500-800 m). The drone's camera may also detect marine animals up to 3 meters between the surface, depending on the visibility. The drone may also comprise of other sensors than normal cameras, for example an infrared camera. It will also be understood that in implementations including a drone, two drones may be provided, with one drone working while the other drone is being charged or held for back-up. Equally, a single drone may be provided with a tether line back to the vessel for power. Advantageously, the use of a drone allows for higher elevations such that the camera angle becomes larger than if placed on the vessel. It will be understood that the drone's positions may be adjusted to comply with regulatory requirements. For example, by regulation, drones have to stay at least 500 feet from North Atlantic Right Whales (NARWs), and hence the detection of a NARW may force the drone move back closer to the vessel.

In this connection, a forward-facing sonar transceiver 6 is provided at the bow of the vessel for detecting submerged bodies ahead of the vessel. In other embodiments, a plurality of sonar transceivers 6 may be provided, with different sonar transceivers operating in different manners and frequencies. The output from the sonar transceiver 6 is fed to the controller 5 for processing to generate sonar images of a water column ahead of the vessel. The transceiver 6 may have a range of up to 1500 m. The sonar frequency may be selected to mitigate the risk of disturbing marine life. Preferably, the detection range is from 0 to around 1500 m as this distance typically provides a sufficient braking or evasive manoeuvring distance for a vessel to avoid a collision. For example, in one illustrative arrangement, a sonar may be used designed for mid-sized vessels greater than 40 m in length at operational speeds of up to 25 knots. Such systems may have a greatest in-water column detection range or up to 1,000 m and a wide field of view of 60 degrees. This may help to maximise the response time to implement mitigation measures for whale detections. Such a sonar may have an operating root-mean-square (rms) source level (SL) of 204 dB re lupa m, with a primary operating frequency of 61 kHz, a pulse duration of 0.007 seconds, and a repetition rate of 0.333 seconds.

A towed submersible 7 may further be provided connected to the vessel 1 and housing additional sensors, such as sonar or thermal cameras for sensing the environment around the vessel. For example, a passive acoustic monitoring (PAM) Sensor may be provided on the towed submersible 7, or the vessel 1 itself or fixed in the area on for example a buoy, tuned to listening for whale sounds. The PAM sensor may be useful for detecting diving whales.

The controller 5 receives inputs from a plurality of environment perception sensors and processes these in combination using a trained neural network model to identify the presence of marine bodies, such as marine animals. For example, sonar images may be used in combination with camera images for enhancing the positive identification of marine bodies.

In this connection, the neural network may be trained by processing a dataset comprising a large plurality of perception sensor images capturing marine bodies, such as whales or corresponding dummies for simulating those bodies. For example, a robotic whale may be used to generate a large number of images simulating the detection of a real whale. Whale skin may be fitted to the robot to help replicate the visual and acoustic characteristics. As such, the surrogate ‘whale’ may act to mimic whale's acoustic signature to facilitate the generation of training data and as well as to help the development of new embodiments. This may be combined with real images to improve the training data set quality. Sample acoustic signatures of whales during active and passive acoustic detection (e.g. sonar and PAM) may also be used to train the neural network. It will be understood that that the training process may include sensors being installed on conventionally operated vessels to collect sample data over an extended period.

The neural network is then used to process a first series of training examples from the dataset. The weights and biases in the neural network are adjusted during the training process to minimize the loss function.

Once the neural network has been trained with the loss function minimised, its performance is evaluated on a second test data set not used during the training process. Fine-tuning of the neural network may be performed, for instance, by adjusting the hyperparameters f the neural network.

Once the neural network model is trained, the marine detection system may be used to process the sensor data from a plurality of the sensors to identify the presence of marine bodies, and particularly whales and other large marine animals ahead of the vessel. In response, the vessel speed may then be automatically reduced, or its course may be automatically diverted to avoid collisions. Advantageously, by combining the environment perception information sensor information from a number of types of sensors, the neural network is able to more accurately identify the presence of marine bodies. For instance, camera image characteristics associated with a whale may be validated by associated characteristics in the sonar images. As such, the confidence in an accurate determination that a marine body is present is increased. At the same time, the range of detection is also increased because whilst sensor noise would typically reduce the confidence of detection at greater distances, this is mitigated by combining sensor results in the aggregate to improve confidence. For example, a weak determination of a whale using sonar data at a 1000 m range may be supported by a detection of a PAM acoustic signal or thermal image from a drone 4. This may thereby mitigate limitations of some sensor types. For instance, PAM is ften limited since whales don't vocalise all the time. PAM will also often be affected by vessel flow noise, which needs to be cancelled. Indeed, this is a main reason why PAM sensors are often provided in a towed submersible as it minimises the influence of vessel noise. Nevertheless, by combining PAM data with other sensor types, the consistency of accurately detecting whales may be further improved.

The consequence of the above is that it may allow the vessel to travel at higher speeds whilst limiting the risk of collisions with marine bodies or minimising the damage if collisions do occur. Regulators may, for example, be willing to lift or ease speed restrictions where it is shown that the risk of collisions is low because the automatic detection of marine bodies is significantly improved. In turn, this provides for significant cost savings since the vessels, such as installation ships and maintenance boats may travel to and from the wind farm site at much higher speeds. This may in turn mean less vessels and staff are needed because a greater proportion of time can be spent on the turbines themselves. Accordingly, embodiments of the invention may provide for a reduced vessel strike risk, whilst the greater speed helps to minimise costs and staffing overheads and reduces staffing sea sickness. For example, the use of the neural network may avoid the need for Protected Species Observers/Marine Mammal Observers to be present. Furthermore, the system may also allow different species of marine mammals to be identified.

It will be understood that the illustrated embodiments show applications only for the purposes of explanation. In practice, the invention may be applied to many different configurations, where the embodiment is straightforward for those skilled in the art to implement.

For example, the above illustrative example focusses on the detection of whales, but it will be understood that other marine bodies, such as other marine life, fishing nets and floating debris may also be detected.

It will also be understood that the neural network may additionally be trained to provide vector information on the travel direction of identified marine bodies. This may be used to determine which direction the vessel should be diverted to avoid collisions. For example, if marine bodies are determined to be travelling across the vessel's path in one direction, the vessel may be steered in the other direction to avoid collision.

In embodiments, different combinations of types of sensors may be used. Other sensor types may also be provided than the ones shown above. For example, satellite, airship or helicopter mounted sensors may be used instead of or in combination with the drone.

It will also be understood that the detection areas associated with different sensors may overlap one other. That is, the sensor's are positionally related relative to one another around the vessel. In instances, where the detection regions overlap, the sensors may therefore receive concurrent detection of marine body characteristics. However, in other scenarios where detection regions do not overlap, detections may occur adjacently in the time domain. For instance, a camera or infrared camera mounted to a drone surveying a further distance ahead of the vessel may identify image characteristics associated with a marine body prior to detection of associated characteristics in sonar or vessel mounted camera images. As such, the neural network may include a memory buffer to track the occurrence of marine body sensor characteristics in the time domain.

In embodiments, the marine detection system may also implement automatic control of the vessel. For example, in the event of a detection, the vessel's speed may be automatically reduced.

Finally, it will be understood that although the marine detection system has been described as being used on travelling vessels, it will be understood that embodiments may be utilised during windfarm installation to, for instance, pause foundation pile driving in the event that marine life is detected in the vicinity. Moreover, it will also be understood that the described marine detection system may be used to provide improved situational awareness for vessels in other sectors, such as in oil & gas, the fish industry, Coast Guards, and Marine Policing. Equally, the technology may be applied to various vessel types, such as autonomous vessels and seagliders. In autonomous vessels, the system may be linked to autonomous navigation systems as an input for controlling vessel steering.

1. A marine detection system for detecting marine bodies, comprising:
a first sensor for detecting marine bodies in a first detection region;
a second sensor for detecting marine bodies in a second detection region, wherein the second sensor is a different type of sensor to the first sensor and at least part of the second detection region overlaps with the first detection region; and
a controller comprising:
a neural network for processing data from the first and second sensors, wherein the neural network is trained to determine the presence of a marine body based on sensor data characteristics in the first and second detection regions, and
an output for outputting a signal indicating the presence of the marine body based on the determination by the neural network.

2. A marine detection system according to claim 1, wherein the first and second detection regions are at a predetermined position relative to a vessel.

3. A marine detection system according to claim 1, wherein the predetermined position is ahead of the vessel in its primary direction of travel.

4. A marine detection system according to claim 2, wherein at least one of the first and second sensors are mounted to the vessel.

5. A marine detection system according to claim 1, further comprising one or more further sensors for detecting marine bodies in one or more further detection regions which overlap with the first or second detection regions, and
wherein the neural network further processes data from the one or more further sensors and is further trained to determine the presence of a marine body based on sensor data characteristics from the further sensors.

6. A marine detection system according to claim 1, wherein the neural network is trained to recognize features associated with marine bodies in the sensor data.

7. A marine detection system according to preceding claim 1, wherein the neural network is configured to have a confidence threshold where a positive detection of a marine body is based on aggregated detection of characteristics associated with marine bodies in the sensor data.

8. A marine detection system according to claim 1, wherein the controller is configured to generate a marine body collision avoidance signal in response to the signal indicating the presence of the marine body.

9. A marine detection system according to claim 1, wherein the neural network is further trained to determine a travel vector of the marine body based on the sensor data characteristics and wherein the output outputs a signal indicating the travel vector of an identified marine body.

10. A marine detection system according to claim 1, wherein the sensors include one or more of the following types: forward facing SONAR, camera, infrared camera, RADAR, and passive acoustic monitoring sensors.

11. A marine detection system according to claim 1, wherein the marine bodies comprise whales.

12. A marine detection system according to claim 1, wherein the controller further comprises a drone controller block for controlling a drone to maintain a predetermined position ahead of a vessel associated with the first and second detection regions, and wherein at least one of the sensors is mounted to the drone.

13. A marine detection method for detecting marine bodies, comprising the steps of:
receiving sensor data from a first sensor for detecting marine bodies in a first detection region;
receiving sensor data from a second sensor for detecting marine bodies in a second detection region, wherein the second sensor is a different type of sensor to the first sensor and at least part of the second detection region overlaps with or is adjacent to the first detection region;
processing data from the first and second sensors using a neural network trained to determine the presence of a marine body based on sensor data characteristics in the first and second detection regions; and
outputting a signal indicating the presence of the marine body based on the determination by the neural network.

14. A marine detection method according to claim 13, wherein the first and second detection regions maintain a predetermined position ahead of a vessel as the vessel moves through the water.

15. A method for training a neural network to detect marine bodies, comprising the steps of:
acquiring a data set of first and second sensor data that includes marine body characteristics, wherein the second sensor is a different type of sensor to the first sensor, and the first and second sensor data are for first and second detection regions, where at least part of the second detection region overlaps with or is adjacent to the first detection region; and
training the neural network using the data set by adjusting weights and biases in the neural network to minimize the loss function.
